(19) United States
(12) Patent Application Publication
(10) Pub. No.: US 2010/0202863 A1
(43) Pub. Date: Aug. 12, 2010

(54) Hand Truck Ramp

(76) Inventor: Keith Raney, St. Petersburg, FL (US)

Correspondence Address: Keith Raney, 9100 9th St. N #1703, St. Petersburg, FL, 33716, US

(21) Appl. No.: 12/651,263

(22) Filed: Dec. 31, 2009

Related U.S. Application Data
(60) Provisional application No. 61/142,209, filed on Jan. 1, 2009.

(51) Int. Cl. B60R 9/06

(52) U.S. Cl. 414/462

(57) ABSTRACT

A hand truck ramp unit mounts to a hand truck rack unit which pivots on hinges.

### RELATED APPLICATION

This application is based upon and claims the benefit of Provisional Application Ser. No. 61/142,209 filed 1 Jan. 2009 which application is incorporated herein by reference.

### BACKGROUND OF THE INVENTION

1. Field of the Invention

The present invention relates generally to a ramp for hand trucks used in manually handling and moving relatively heavy loads. More particularly, the invention relates to lifting and storing heavy hand trucks.

2. Description of the Prior Art

For many years, people have used conventional hand trucks carriers to carry hand truck on the back of beverage delivery trucks and automobiles. Most conventional hand truck carriers are based on some variation of an “L” shaped frame with one opening at the bottom. When the person using the conventional hand truck lift he/she has to lift the hand truck vertically and place the bottom hand truck plate into an open slot. The user then attaches a mounting bracket to secure the hand truck onto the hand truck carrier.

When removing a hand truck from a conventional hand truck carrier the user had to unlatch the mounting bracket that secures the hand truck. The user then lifts the hand truck vertically and the places the hand truck of flat ground. Some hand trucks are very heavy and require a tremendous amount of energy to lift.

A conventional hand truck carrier is typically attached to the back of a beverage delivery trailer which is used to transport the users hand truck. People use hand trucks to assist in delivering product to facilities.

In view of the foregoing, there is a need for improved techniques for loading and lifting hand trucks that reduces or eliminates the need to lift the hand truck.

### BRIEF DESCRIPTION OF THE DRAWINGS

The present invention is illustrated by way of example, and not by way of limitation, in the figure of the accompanying drawings and in which like reference numerals refer to similar elements and in which:

FIG. 1 illustrates a perspective view of a hand truck ramp unit 100 attached to the truck or automobile, in accordance with an embodiment of the present invention. Hand truck ramp unit 100 mounts to a hand truck rack unit 101 which pivots on hinges. Unless otherwise indicated illustrations in the figure are not necessarily drawn to scale.

### DETAILED DESCRIPTION OF THE PREFERRED EMBODIMENTS

The present invention is best understood by reference to the detailed figure and description set forth herein.

Embodiments of the invention are discussed below with reference to the Figure. However, those skilled in the art will readily appreciate that the detailed description given herein with respect to these figures is for explanatory purposes as the invention extends beyond these limited embodiments.

An aspect of the invention provides a hand truck ramp unit 100 that can properly impose lifting force of a hand truck to assist in lifting and transporting.

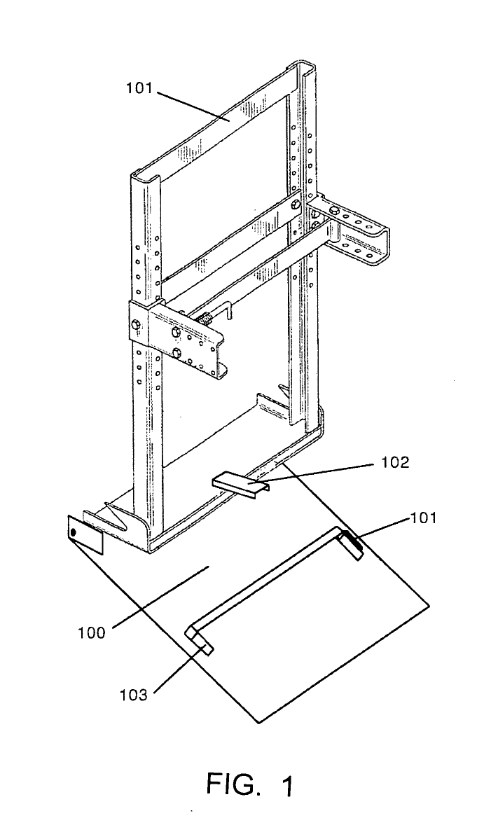

FIG. 1 illustrates a perspective view of an exemplary hand truck ramp unit 100 in accordance with an embodiment of the present invention joined to a properly adapted exemplary hand truck carrier.

In a preferred embodiment, the present invention is an add-on, or after market, component, which provides lift and power when transporting a hand truck. The present embodiment is a detachable hand truck ramp component, which attaches to a hand truck rack unit 101 to effectively lift the hand truck. A conventional hand truck rack may be suitably adapted to work with the present embodiment by attaching the mounting bracket to a hand truck rack that properly mates with the mounting bracket located on the hand truck lift.

As shown in FIG. 1 hand truck ramp 100 is in the horizontal position. In the embodiment shown, to use hand truck ramp unit 100 the user simply uses the front plate of the hand truck to push the hand truck ramp unit 100 vertical to the ground. The user then drives a powered hand truck up the ramp unit the front plate reaches the stop plate. The user then pushes on the top portion of the powered hand trucks handle. This will cause the front plate to pivot which moves the hand truck in a vertical position. The user then lock the support bar located on their existing hand truck carrier. The spring pin unit 101 holds the hand truck ramp 100 vertically when not holding or transporting a hand truck.

Typical applications of the present invention include, by way of example, commercial moving application, by way of example, and not limitation, food, beverage, shipping and moving organizations, which use hand trucks (e.g., of the four-wheel type) to move 300-1200 lbs of product at one time. This is a very difficult amount of weight for a person to lift, including powered hand truck. By attaching the hand truck ramp unit 100 of the present invention, the user uses minimal amount of force to load and unload a hand truck. This greatly tends to decreases back and leg strain, and injury related insurance claims.

Having fully described at least one embodiment of the present invention, other equivalent or alternative techniques of achieving for the lifting of hand trucks according to the present invention will be apparent to those skilled in the art.

The invention has been described above by way of illustration, and the specific embodiments disclosed are not intended to limit the invention to the particular forms disclosed. The described embodiments in the foregoing were directed to hand truck carriers implementations; however, similar techniques are readily applied to any hand truck carrier of suitable size and configuration. Moreover, non-aftermarket (i.e., originally manufactured) implementations of the present invention are contemplated as within the scope of the present invention. The invention is thus to cover all modifications, equivalents, and alternatives falling within the spirit and scope of the following claims.

I claim:

1. An attachable hand truck ramp, comprising:
a heavy-duty platform;
hinge mounted to pivot; and
springs attached to side on platform.

2. The hand truck ramp of claim 1 further comprising means for lifting a hand truck vertically.

3. The hand truck ramp of claim 1 where the mounting brackets are mounted to the rear of a truck or automobile.
